(19) United States
(12) Patent Application Publication
(10) Pub. No.: US 2024/0095768 A1
(43) Pub. Date: Mar. 21, 2024

(54) A METHOD OF ADVERTISING USING SKILL-BASED GAMING

(71) Applicant: Warren BEDIL, Johannesburg (ZA)

(72) Inventor: Warren BEDIL, Johannesburg (ZA)

(21) Appl. No.: 18/039,507

(22) PCT Filed: Apr. 21, 2021
(86) PCT No.: PCT/IB2021/053282

§ 371 Date: May 31, 2023

(30) Foreign Application Priority Data
Dec. 21, 2020 (ZA) 2020/07966

(51) Int. Cl. G06Q 30/0207; G06Q 30/0241

(52) U.S. Cl. CPC G06Q 30/0209; G06Q 30/0277

(57) ABSTRACT

A method of advertising using an AV display, wherein the AV display having suitably enabling software and hardware is controlled by a software app installed on the MCD of the user comprising the steps of: using a suitably enabled and configured software app to activate a skill-based game utilising the advertisement of a brand as the basis of the game, wherein identification of the brand results in the participant being eligible to win a prize. Brand identification occurs by the participant following prompts generated by the app to input the brand and inputting the brand identified. The software app conditioning the awarding of a prize on the participant viewing an advertisement. The advertisement content displayed is related to the brand upon which the initial skill-based brand identification is based.

The present invention relates to method of advertising using skill-based gaming on an audio-visual display.

### BACKGROUND

The display of relevant advertising content to a potential customer in a targeted and relevant manner is a well-known goal of advertisers. Additionally, targeted advertising aims to display relevant individualised advertising content to a viewer frequently and in an environment where the viewer would be receptive to the advertising content.

Of particular relevance to the invention is the ability to effectively encourage or ensure that a potential customer views advertising content to completion on their audio visual display (AV display) devices without skipping or avoiding at least part of the advertising content at time of display. This phenomenon is experienced through platforms such as Youtube wherein a user will skip the advertisement as soon as possible. Alternately, where a mandatary advertisement must be watched to continue —the user substantially ignores the AV display content until the desired content resumes. Such advertising content is often resented by a viewer and negative associations may be developed with such unsolicited brands advertised.

It is also a well-known concept in advertising that where a targeted audience opts-in to a type of advertisement platform such as competitions—they are more likely to be receptive to the advertising content delivered using such platform. The impact value of such advertising content is thus more potent and of greater value to the advertiser.

Prior art methods of advertising include flighting adverts prior to a user viewing audio visual content such as done by www.youtube.com; or during use of apps that offer free-use subject to the periodic viewing of advertising content. There are several disadvantages and limitations with such method of advertising in providing relevant targeted advertising. These include the inability to provide accurately targeted adverts to unsubscribed users, whereby advertising content is merely guided by cookies pursuant to a user's browsing history. This history is often of limited value and may be reset by the user periodically to further limit the accuracy of using such cookies in displaying relevant adverts. As potential users often do not have compelling reasons to always provide accurate and constantly updated personal data, which data would ensure advertising content remains relevant and targeted. More particularly, the existing methods of advertising cannot force audience captivity and as such are unable to continuously and accurately provide targeted advertising. Advertising on platforms such as Youtube are similarly limited to times when a user browses the platform. Adverts are also not necessarily flighted at the most opportune time for optimal user impact. By example, a food product of interest to a purchaser will be most effectively advertised at a time when they are actively involved in purchasing food products.

The invention seeks to provide a method of advertising on audio visual displays that at least partially ameliorates the abovementioned disadvantages associated with prior art methods and apparatus used to display of advertising content.

In this specification, the term audio visual display (AV display) includes screens which are able to electronically display or project visual content against another surface. Such displays additionally are connected to or have an integral audio output functionality. The term mobile communication device (MCD) includes computing devices having hardware and software to enable the MCD to download and operate a software app which is used in accordance with the invention and to wirelessly communicate and control the audio visual display.

Further, the term brand includes any component of a brand including a word mark, logo, slogan, image or audio track used to advertise a brand.

### SUMMARY OF INVENTION

According to the invention there is provided a method of advertising using an AV display, wherein the AV display having suitably enabling software and hardware is controlled by a software app installed on the MCD of the user comprising the steps of: using a suitably enabled and configured software app to activate a skill-based game utilising the advertisement of a brand as the basis of the game, wherein identification of the brand results in the participant being eligible to win a prize. Brand identification occurs by the participant following prompts generated by the app to input the brand and inputting the brand identified.

Conveniently the steps further include the software app conditioning the awarding of a prize on the participant viewing an advertisement.

Conveniently the advertisement content displayed is related to the brand upon which the initial skill-based brand identification is based. As will be appreciated, the brand which is identified as part of the game may be changed in accordance with advertisement requirements of the game operator.

Conveniently the brand selected for identification may be determined in accordance with participant relevance parameters. By example, a participant who has an interest in electronic goods—will be served a brand to identify from an electronics goods category. This ensures a participant is served a brand to identify as part of the game; and a subsequent advert of such brand is served for a product type, which is actively being sought by the participant.

Conveniently, prior to the commencement of the game, alternately upon the successful completion of the game—the participant receives a prompt as to the category of goods which is of interest to them. This enables a specific category of product to be advertised to the participant making the advert served more targeted.

Conveniently upon completion of the game and viewing the advertisement, a participant results board display is generated whereby participant results are displayed.

Conveniently, participants may challenge each other to a further skill-based brand identification game, wherein there is a benefit to the challenging participants engaging in the challenge.

Conveniently the winner of such challenge results in at least one of: their participant position on the results board improving; obtaining entry into an additional competition; awarding the participant with a prize allocated for challengers.

Conveniently a voucher is generated and provided to participants after having completed viewing the advertisement. Preferably the voucher will be related to the brand which is the subject of the brand identification game.

Conveniently the prize won is dependent on at least one of: the position a participant is placed among other successful participants; the duration the participant takes to complete the skill-based game; the time taken for a participant to commence playing the game upon the game being made available to participants; the quantity and/or duration of adverts viewed by the participant over a period of time.

Conveniently the skill-based game requires the participant to correctly identify a brand, wherein a section of the brand or brand packaging is initially displayed at commencement of the game whereafter the brand display expands over a period of time to reveal a continually expanding section of the brand until a substantial, alternately entire display of the brand is revealed. The parameters for determining a participant position on the game results board is determined by the time and/or size of the brand section displayed before the participant correctly identifies the brand by following the software app input prompts.

Conveniently the skill-based game requires the participant to correctly identify a brand, wherein the brand to be identified is hidden within an image displayed. The parameters for determining a participant position on the game results board is determined by the time taken for the participant to locate the brand by following the software app input prompts.

Further features, variants and/or advantages of the invention will emerge from the following non-limiting description of an example of the invention.

### DETAILED DESCRIPTION OF THE INVENTION

According to the invention there is provided a method of providing targeted advertising to an AV display device of a user, which advertising is flighted after the user opens a software app of the invention and commences playing a skill-based brand identification game. In a preferred embodiment of the invention, the AV display is a mobile device such as a smart phone or tablet comprising suitably enabled software and hardware to operate the software app of the invention.

The skill-based game comprises the steps of utilising the advertisement of a brand as the basis of the game, wherein identification of the brand results in the participant being eligible to win a prize. Brand identification occurs by the participant following prompts generated by the app to input the brand; and the participant inputting the brand identified. The software app conditions the awarding of a prize on the participant viewing an advertisement.

The advertisement content displayed is related to the brand upon which the initial skill-based brand identification is based. As will be appreciated, the brand which is identified as part of the game may be changed in accordance with advertisement requirements of the game operator.

The brand selected for identification may be determined in accordance with participant relevance parameters. By example, a participant who has an interest in electronic goods—will be served a brand to identify from an electronics goods category. This ensures a participant is served a brand to identify and a subsequent advert of such brand is served for a product type, which is actively being sought by the participant. By illustration of the converse—a seventy year old single male is unlikely to ever purchase a female sanitary wear product for himself.

In a preferred embodiment of the invention—prior to the commencement of the game, alternately upon the successful completion of the game—the participant receives a prompt as to the category of goods which is of interest to them. This enables a specific category of product to be advertised to the participant making the advert served more targeted.

Upon completion of the game and viewing the advertisement, a participant results board display is generated whereby participant results are displayed. Participants may challenge each other to a further skill-based brand identification game, wherein there is a benefit to the challenging participants engaging in the challenge. This results in further brand engagement for which advertising cost may be attributed to an advertiser. The winner of such challenge results in at least one of: their participant position on the leader board improving; obtaining entry into an additional competition; awarding the participant with a prize allocated for challengers.

A voucher is generated and provided to participants after having completed viewing the advertisement. Preferably the voucher will be related to the brand which is the subject of the brand identification game. The prize won is dependent on at least one of: the position a participant is placed among other successful participants; the duration the participant takes to complete the skill-based game; the time taken for a participant to commence playing the game upon the game being made available to participants; the quantity and/or duration of adverts viewed by the participant over a period of time.

In one embodiment of the invention the skill-based game requires the participant to correctly identify a brand, wherein a section of the brand or brand packaging is initially displayed at commencement of the game whereafter the brand display expands over a period of time to reveal a continually expanding section of the brand until a substantial, alternately entire display of the brand is revealed. The parameters for determining a participant position on the game results board is determined by the time and/or size of the brand section displayed before the participant correctly identifies the brand by following the software app input prompts.

In another embodiment of the invention the skill-based game requires the participant to correctly identify a brand, wherein the brand to be identified is hidden within an image displayed. The parameters for determining a participant position on the game results board is determined by the time taken for the participant to locate the brand by following the software app input prompts. The location of the hidden brand is selected by the participant touching a touch screen, alternately using a mouse pointer to select the location of the brand.

In a preferred embodiment the software app of the invention provides a skill-based mobile game played on a smart device providing every registered user with an opportunity to win a share of a cash or a cash equivalent prize every week. Participant entrance is free and the game is broadcast simultaneously to the widest possible audience through digital channels. The software app records all participant entries and results on a server which is accessible by participants using the software app. The fastest correct participants will win their share of the cash or cash equivalent prize on a pre-determined sliding pay scale.

The preferred embodiment provides a four-phase participant engagement advertising model, namely:
Playing a skill-based brand identification game;
Serving the participant a brand and retail messaging adverts;
Generating a results board with participant results; and
Generating a voucher for successful participants.

Each game participant is required to complete each of the four phases of participant engagement in order to win. Accordingly, exiting the app at any point before completion of all four phases will eliminate the participant.

The software app of the invention thus provides authentic and unprompted brand engagement with pursuant deep analytics on brand and product awareness, recognition and engagement.

Accordingly, the invention thus provides a zero-risk cost per viewer performance based metric where total cost is based exclusively on the number of participants.

What is unique and inventive about the invention is how the method of advertisement gamification, using expanding brand reveals under time constraints—results in an unexpectedly high user engagement with the advertising content that is not found using any other known method of advertising.

By illustration, one embodiment of the invention provides participants with a selection of advertisements to watch prior to the skill-based game commencing. Of this batch of advertisements, one of the advertisements contain the brand selected for the brand reveal. Using software tracking analytics— it has been revealed that game participants will repeatedly view the potential adverts prior to the game commencement. Advertisement viewing is often repeated by game participants with the intention to “study” the advertisement in order to more rapidly identify the brand, brand logo or brand slogan to be revealed. Tracking metrics thus reveal game participants attempt to learn the brand, brand logo or brand slogan for rapid identification. Such intense engagement with advertising content is unparalleled by the prior art and of massive benefit to advertisers attempting to create brand recognition.

The method of advertisement of the invention thereby enables the rapid development of brand recognition even with brands previously unknown to a participant. Traditional advertisement methods require far more advertisement flightings and repeated exposure to the advertising content to achieve an inferior brand recognition relative to the invention.

The invention is not limited to the precise details described above. Modifications may be made and other embodiments developed without departing from the spirit of the invention. For example, participants would receive notification of an upcoming gaming event thereby enabling a participant to be eligible for an early participation prize. Additionally, participants may receive notifications as to their leader board rankings and be provided with prompts to challenge other participants.

The summary of invention and claims form an integral aspect of the description of the invention.

The following are particular aspects of the invention:
1. A method of advertising using an AV display, wherein the AV display having suitably enabling software and hardware is controlled by a software app installed on the MCD of the user comprising the steps of: using a suitably enabled and configured software app to activate a skill-based game utilising the advertisement of a brand as the basis of the game, wherein identification of the brand results in a participant being eligible to win a prize; and where brand identification occurs by the participant following prompts generated by the app to identify the brand and subsequently inputting the brand identified.
2. The method of advertising using the AV display as claimed in claim 1, wherein the steps further include the software app conditioning the awarding of a prize on the participant viewing an advertisement.
3. The method of advertising using the AV display as claimed in claim 1 or 2, wherein the advertisement content displayed is related to the brand upon which the initial skill-based brand identification is based.
4. The method of advertising using the AV display as claimed in any one of claims 1 to 3, wherein the brand selected for identification may be determined in accordance with participant relevance parameters.
5. The method of advertising using the AV display as claimed in anyone of claims 1 to 4, wherein prior to the commencement of the game, alternately upon the successful completion of the game—the participant receives a prompt as to the category of goods which is of interest to them.
6. The method of advertising using the AV display as claimed in anyone of claims 1 to 5, wherein upon completion of the game and viewing the advertisement, a participant results board display is generated whereby participant results are displayed.
7. The method of advertising using the AV display as claimed in anyone of claims 1 to 6, wherein a voucher is generated and provided to participants after having completed viewing the advertisement.
8. The method of advertising using the AV display as claimed in anyone of claims 1 to 7, wherein the prize won is dependent on at least one of: the position a participant is placed among other successful participants; the duration the participant takes to complete the skill-based game; the time taken for a participant to commence playing the game upon the game being made available to participants; the quantity and/or duration of adverts viewed by the participant over a period of time.
9. The method of advertising using the AV display as claimed in anyone of claims 1 to 8, wherein the skill-based game requires the participant to correctly identify a brand, wherein a section of the brand or brand packaging is initially displayed at commencement of the game whereafter the brand display expands over a period of time to reveal a continually expanding section of the brand until a substantial, alternately entire display of the brand is revealed; the parameters for determining a participant position on the game results board is determined by the time and/or size of the brand section displayed before the participant correctly identifies the brand by following the software app input prompts.
10. The method of advertising using the AV display as claimed in anyone of claims 1 to 8, wherein the skill-based game requires the participant to correctly identify a brand, wherein the brand to be identified is hidden within an image displayed; the parameters for determining a participant position on the game results board is determined by the time taken for the participant to locate the brand by following the software app input prompts.
11. The method of advertising using the AV display as claimed in anyone of claims 1 to 10, wherein participants may challenge each other to a further skill-based brand identification game, wherein there is a participant benefit to the challenging participants engaging in the challenge.
12. The method of advertising using the AV display as claimed in claim 11, wherein the winner of such challenge results in at least one of: their participant position on the leader board improving; obtaining entry into an additional competition; or awarding the participant with a prize allocated for challengers.

1. A method of advertising using an audio visual (AV) display, wherein the AV display having suitably enabling software and hardware is controlled by a software app installed on a computing device of a user comprising the steps of: using a suitably enabled and configured software application to activate a skill-based game utilising the advertisement of a brand as the basis of the game, wherein identification of the brand results in a participant being eligible to win a prize; and where brand identification occurs by the participant following prompts generated by the app to identify the brand and subsequently inputting the brand identified.

2. The method of advertising using the AV display as claimed in claim 1, wherein the steps further include the software app conditioning the awarding of a prize on the participant viewing an advertisement.

3. The method of advertising using the AV display as claimed in claim 2, wherein the advertisement content revealed is related to the brand upon which the initial skill-based brand identification is based.

4. The method of advertising using the AV display as claimed in any claim 2, wherein the brand selected for identification may be determined in accordance with participant relevance parameters.

5. The method of advertising using the AV display as claimed in claim 1, wherein prior to the commencement of the skill-based game, alternately upon the successful completion of the game—the participant receives a prompt as to the category of goods which is of interest to them.

6. The method of advertising using the AV display as claimed in claim 1, wherein upon completion of the game and viewing the advertisement, a participant results board display is generated whereby participant results are displayed.

7. The method of advertising using the AV display as claimed in claim 1, wherein a voucher is generated and provided to participants after having completed viewing the advertisement.

8. The method of advertising using the AV display as claimed in claim 1, wherein the prize won is dependent on at least one of: a participant ranking relative to other successful participants; the duration the participant takes to complete the skill-based game; the time taken for a participant to commence playing the game upon the game being made available to participants; the quantity alternately the duration of adverts viewed by the participant over a period of time.

9. The method of advertising using the AV display as claimed in claim 1, wherein the skill-based game requires the participant to correctly identify a brand, wherein a section of the brand or brand packaging is initially revealed at commencement of the game whereafter a continually expanding section of the brand is revealed over a period of time until a substantial, alternately the entire component of the brand is revealed; the parameters for determining a participant position on the game results board is determined by the time, alternately the extent of the brand section revealed before the participant correctly identifies the brand by following the software app input prompts.

10. The method of advertising using the AV display as claimed in claim 2, wherein the skill-based game requires the participant to correctly identify a brand, wherein a section of the brand or brand packaging is initially revealed at commencement of the game whereafter a continually expanding section of the brand is revealed over a period of time until a substantial, alternately the entire component of the brand is revealed; the parameters for determining a participant position on the game results board is determined by the time, alternately the extent of the brand section revealed before the participant correctly identifies the brand by following the software app input prompts.

11. The method of advertising using the AV display as claimed in claim 1, wherein the skill-based game requires the participant to correctly identify a brand, wherein the brand to be identified is hidden within an image displayed; the parameters for determining a participant position on the game results board is determined by the time taken for the participant to locate the brand by following the software app input prompts.

12. The method of advertising using the AV display as claimed in claim 1, wherein participants may challenge each other to a further skill-based brand identification game, wherein there is a participant benefit to the challenging participants engaging in the challenge.

13. The method of advertising using the AV display as claimed in claim 12, wherein the winner of such challenge results in at least one of: the winning participant position on the leader board improving; obtaining entry into an additional competition; or awarding the participant with a prize allocated for challengers.
